(19) United States
(12) Patent Application Publication
(10) Pub. No.: US 2016/0313490 A1
(43) Pub. Date: Oct. 27, 2016

(54) INTEGRATED LIGHT SOURCE IN RECESS OF HOUSING

(71) Applicant: Sony Mobile Communications Inc., Tokyo (JP)

(72) Inventors: Magnus Steijner, Loddekopinge (SE); Martin Ek, Lund (SE); Alexander Hunt, Tygelsjo (SE); Martin Grip, Hollviken (SE)

(21) Appl. No.: 14/744,219

(22) Filed: Jun. 19, 2015

Related U.S. Application Data
(60) Provisional application No. 62/151,037, filed on Apr. 22, 2015.

(51) Int. Cl. F21V 8/00; G02F 1/1333

(52) U.S. Cl. CPC G02B 6/0021; G02B 6/0083; G02B 6/0073; G02F 1/13338

(57) ABSTRACT

A device may comprise a housing, wherein the housing comprises one or more recesses; a display panel; a backlight; one or more light sources, wherein within each of the one or more recesses of the housing, one or more of the one or more light sources reside and are configured to emit light into the backlight; and a printed circuit board, wherein each of the one or more of the one or more light sources are connected to the printed circuit board, wherein each of the one or more recesses comprises at least one wall that comprises an electrical attachment area for the one or more of the one or more light sources.

### CROSS REFERENCE TO RELATED APPLICATION

This application claims priority under 35 U.S.C. §119 based on U.S. provisional application No. 62/151,037, filed on Apr. 22, 2015, the disclosure of which is hereby incorporated by reference herein in its entirety.

### BACKGROUND

A device, such as a mobile device or a wearable device, offers various services to its user. One problem confronted by designers and manufacturers is to maximize the availability of the active area of the display to the users. For example, the size of the border of the display can diminish the active area of the display that is available to the user.

### SUMMARY

According to one aspect, a device may comprise a housing, wherein the housing comprises one or more recesses; a display panel; a backlight; one or more light sources, wherein within each of the one or more recesses of the housing, one or more of the one or more light sources reside and are configured to emit light into the backlight; and a printed circuit board, wherein each of the one or more of the one or more light sources are connected to the printed circuit board, and wherein each of the one or more recesses comprises at least one wall that comprises an electrical attachment area for the one or more of the one or more light sources.

According to another aspect, a user device may comprise a housing, wherein the housing comprises one or more recesses; a display panel; a backlight; one or more light sources, wherein within each of the one or more recesses of the housing, one or more of the one or more light sources reside and are configured to emit light into the backlight; and a printed circuit board, wherein each of the one or more of the one or more light sources are connected to the printed circuit board, wherein each of the one or more recesses comprises at least one wall that comprises an electrical attachment area for the one or more of the one or more light sources, and wherein the printed circuit board comprises a memory, a processor, and a management unit that transmits driving signals to the one or more light sources.

According to yet another aspect, a device may comprise a housing, wherein the housing comprises one or more recesses; a display panel; a touch panel operable in at least one of an on-touch mode or a touchless mode; a backlight; one or more light sources, wherein within each of the one or more recesses of the housing, one or more of the one or more light sources reside and are configured to emit light into the backlight; and a printed circuit board, wherein each of the one or more of the one or more light sources are connected to the printed circuit board, and wherein each of the one or more recesses comprises at least one wall that comprises an electrical attachment area for the one or more of the one or more light sources.

### DESCRIPTION OF THE DRAWINGS

FIG. 1A illustrates an isometric, cross-sectional view of an exemplary embodiment of a display configuration comprising an integrated light source in a recess of a housing;

FIGS. 1B through 1G illustrate other views and exemplary embodiments of display configurations comprising an integrated light source in a recess of a housing;

FIG. 2 illustrates a top view of an exemplary embodiment of a display configuration comprising an integrated light source in a recess of a housing;

FIGS. 3A and 3B illustrate cross-sectional views of exemplary embodiments of a display configuration that comprises an integrated light source in a recess of a housing;

FIG. 3C illustrates an isometric view of a connector;

FIG. 3D illustrates an exemplary configuration of the recess that comprises guiding holes for a portion of a backlight;

FIG. 4 illustrates an exemplary user device in which an embodiment of the display configuration comprising an integrated light source in a recess of a housing may be implemented;

FIG. 5 illustrates another exemplary user device in which an embodiment of the display configuration comprising an integrated light source in a recess of a housing may be implemented;

FIG. 6 illustrates exemplary components of the user devices depicted in FIGS. 4 and 5; and

FIG. 7 is a flow diagram illustrating an exemplary process for creating an article of manufacture that comprises a recess portion of a housing.

### DETAILED DESCRIPTION OF PREFERRED EMBODIMENTS

The following detailed description refers to the accompanying drawings. The same reference numbers in different drawings may identify the same or similar elements.

A configuration for a display, which may or may not be a touch display and/or a touchless display (simply referred to herein as “display”), can limit the possibilities of shape and/or size of certain components of the display. For example, an active area of the display may be restricted in terms of shape and available size in view of the configuration and/or architecture of a component of the display.

In order to achieve thin borders all around a display, there are various problems that need to be addressed. For example, a flexible printed circuit (FPC) attachment area that routes signals from the FPC attachment area to a driver (e.g., display driver, touch and/or touchless driver), and light source placement may cause issues with respect to achieving narrow borders. With regard to light source placement, currently for example, approximately 2 millimeters (mm) is needed from the die of a light emitting diode (LED) to the outer edge of the active area. The dimension of the LED may also be approximately 0.8 mm. Thus, a minimum border area for a display using an LED backlight system is approximately 2.8 mm. If the FPC attachment area is disregarded, a manufacturer may achieve a 0.6 mm border corresponding to a distance from the active area of the display to an end of the display module.

According to an exemplary embodiment, a housing of a device or an inner structure (e.g., a frame or other type of support structure) of a device (simply referred to as “housing”) is used to physically support, position, and electrically provide for the light source of a display. According to an exemplary embodiment, the housing comprises a recess configured for the light source. For example, the recess may be implemented as an indentation, a cut-out, or a notch in the housing. According to an exemplary implementation, the light source comprises one or multiple LEDs.

According to an exemplary embodiment, the recess is configured for a portion of a backlight. For example, the portion of the backlight may protrude or extend into the recess in a space that is proximate to one or multiple sides of the light source. In this way, light emitted from the light source may enter or be received by the backlight.

According to an exemplary embodiment, the recess comprises an electrical coupling between the light source and a printed circuit board. According to an exemplary implementation, the printed circuit board is a main printed circuit board of a user device that includes the display or a dedicated printed circuit board for the display. According to another exemplary implementation, the printed circuit board may be a flexible printed circuit (FPC), a flex foil, a glass panel, a chip-on-glass, a chip-on-flex, or other type of substrate that allows the propagation of signals and connects to the main printed circuit board. In this regard, the term “printed circuit board” is intended to be broadly interpreted. For example, the printed circuit board may comprise a power source and/or logic that communicates signals to the light source, or the printed circuit board may be an intermediary component that supplies power signals and/or communicates signals to and/or from the light source.

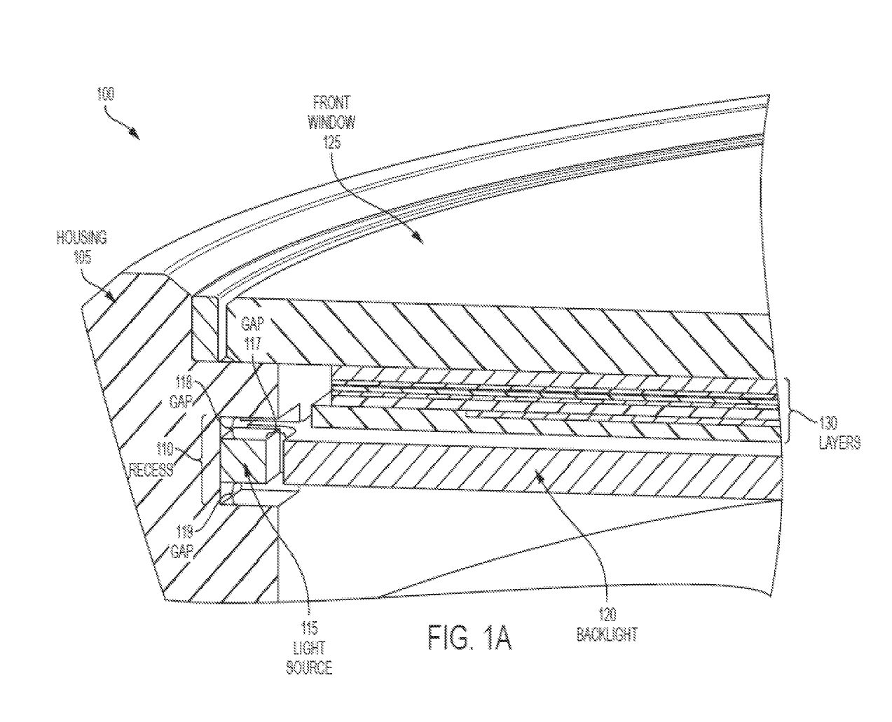

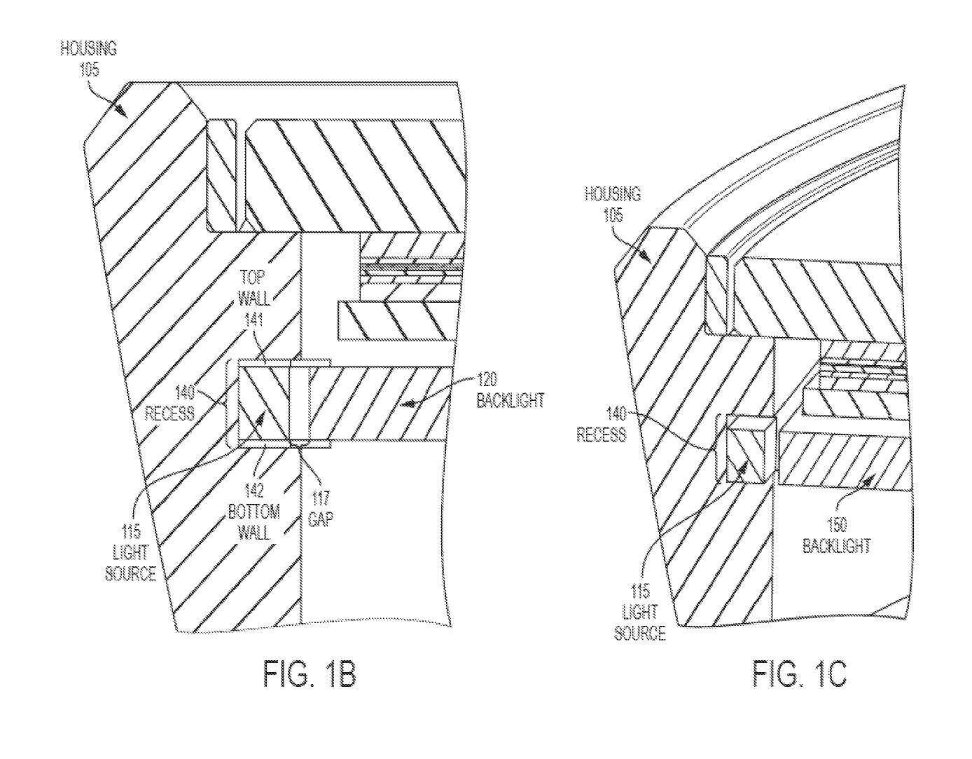

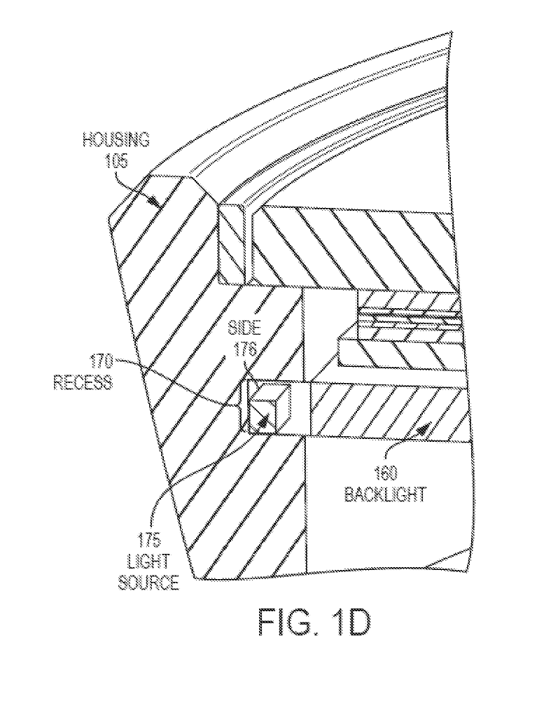

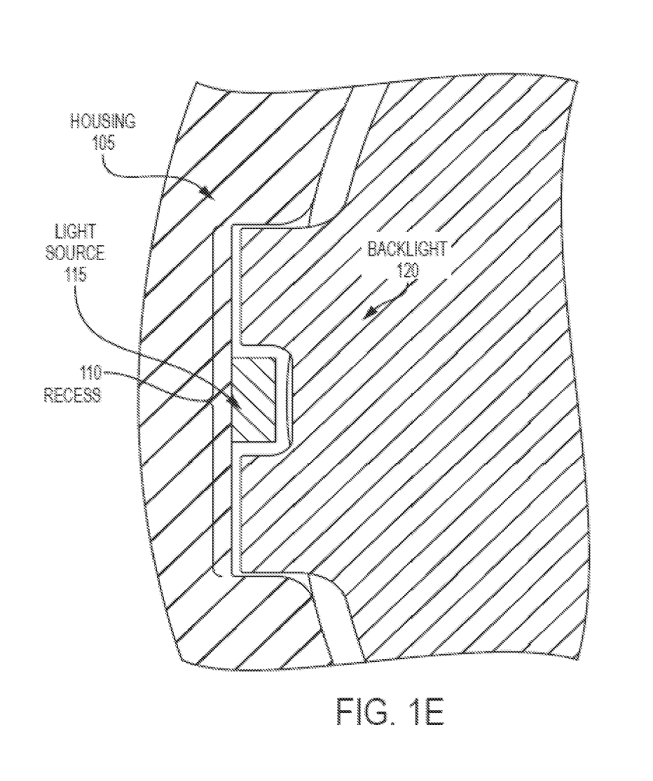

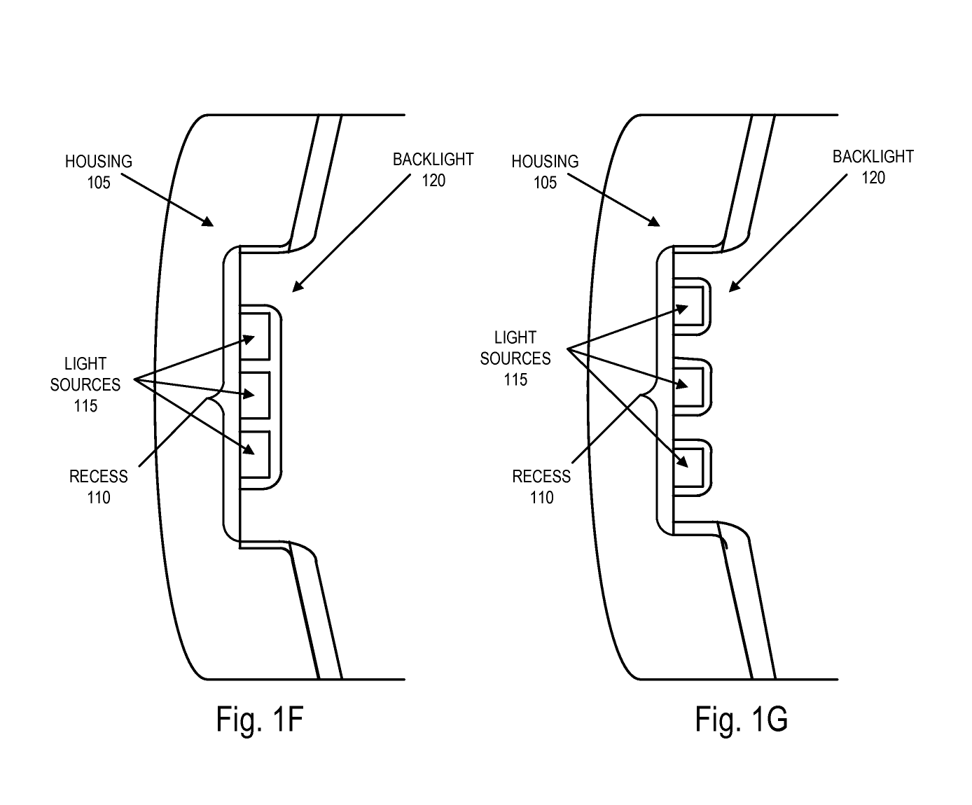

FIG. 1A illustrates an isometric, cross-sectional view of an exemplary embodiment of a display configuration 100 comprising an integrated light source in a recess of a housing of a device. As illustrated, display configuration 100 comprises a housing 105, which comprises a recess 110, a light source 115, a backlight 120, a front window 125, and layers 130.

Housing 105 comprises a structure to contain components of a display. For example, housing 105 may be formed from plastic, metal, or some other type of material (e.g., a composite, etc.). Housing 105 may support various components of a display, such as light source 115, backlight 120, front window 125, etc. According to an exemplary embodiment, housing 105 comprises recess 110.

As illustrated in FIG. 1A, recess 110 comprises a recess in housing 105. The dimensions of recess 110 depend on the size of light source 115. Additionally, according to an exemplary implementation, the dimensions of recess 110 depend on the dimensions of the portion of backlight 120 that protrudes or extends into recess 110. As described further below, according to another exemplary implementation, as illustrated in FIG. 1C, the dimensions of recess 110 do not depend on the dimensions of a protruding portion of backlight 120. That is, according to other exemplary implementations, a backlight 150 does not protrude into an area defined by a recess 140, as illustrated in FIG. 1C. Additionally, or alternatively, while FIG. 1A illustrates that recess 110 provides a gap 118 above light source 115 and a gap 119 below light source 115, according to other implementations, as described further below in relation to FIG. 1B and other figures, recess 140 may not includes gap 118 and gap 119.

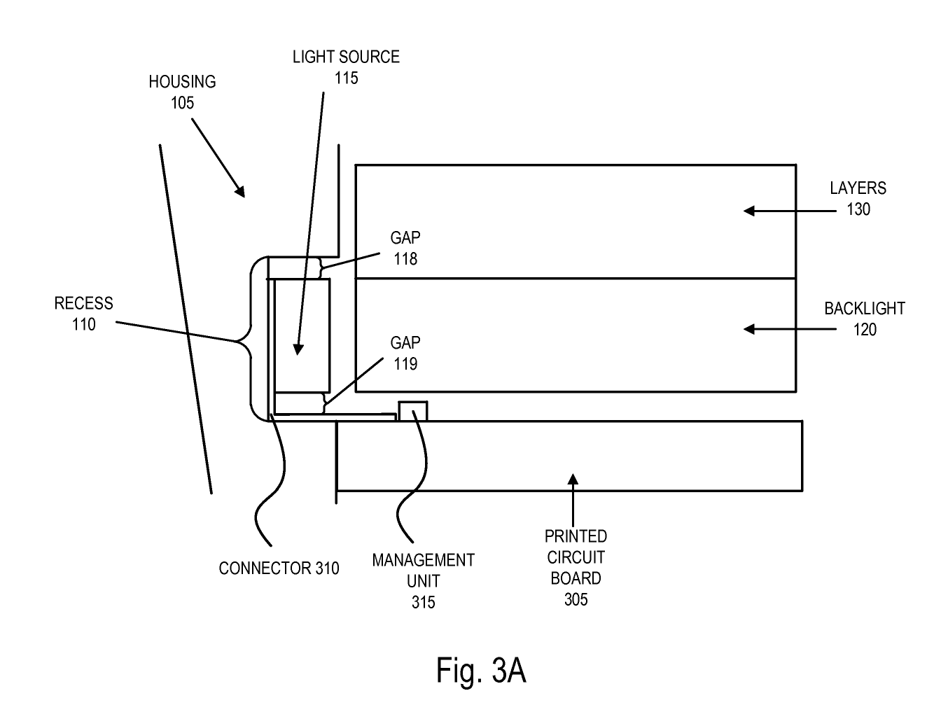

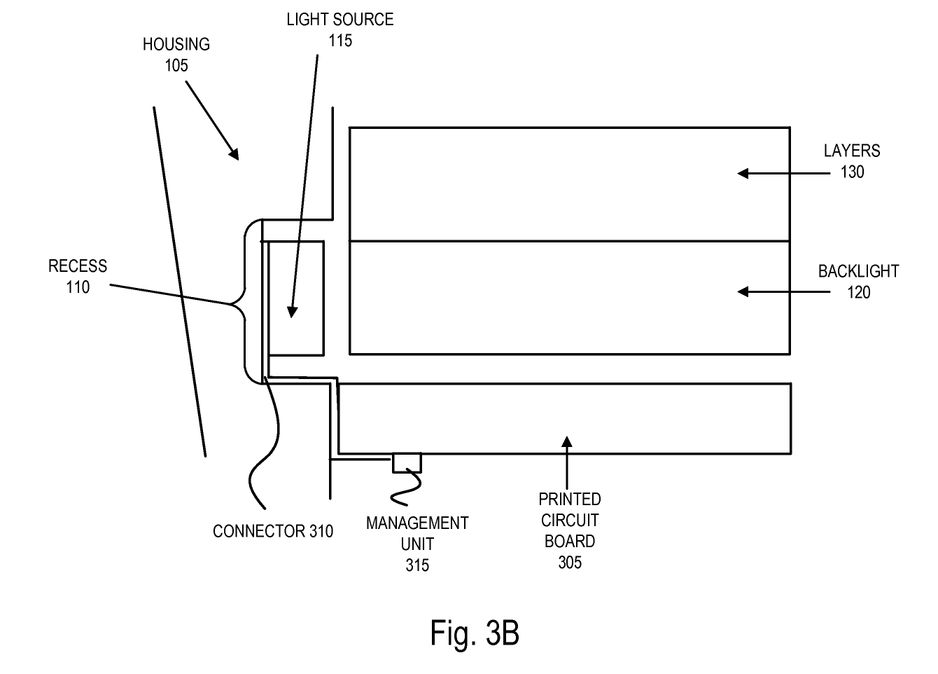

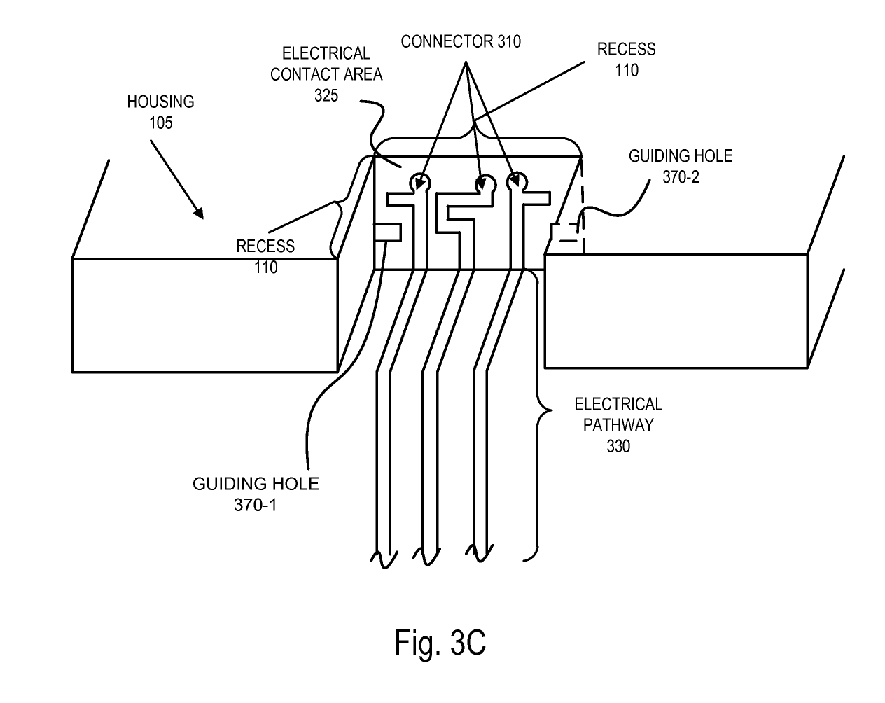

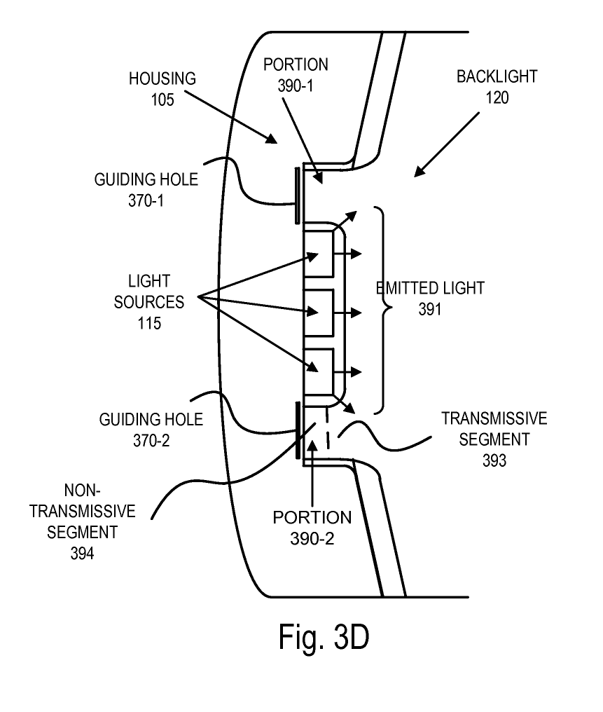

As illustrated in other figures, such as FIGS. 3A and 3B, and described elsewhere in this description, according to an exemplary embodiment, recess 110 comprises an electrical contact area for light source 115 and an electrical pathway from the electrical contact area towards a printed circuit board. For example, a light management unit (LMU) or a power management unit (PMU) drives light source 115 via the electrical contact area and the electrical pathway. Other portions of housing 105 may comprise an electrical pathway towards the printed circuit board, as illustrated and described further below.

Light source 115 comprises a device that emits light. According to an exemplary implementation, light source 115 comprises one or multiple LEDs. According to another exemplary implementation, light source 115 comprises one or multiple laser diodes. A diffusing film may be used to spread light emitted from light source 115.

Backlight 120 comprises a mechanism that provides light, such as from light source 115, to allow a display layer to produce a visible image. Backlight 120 comprises a light guide. According to the various implementations described herein, a portion of backlight 120 may or may not protrude into recess 110. According to an exemplary implementation, as illustrated in FIG. 1D, the portion of a backlight 160 may encase or surround light source 115 on all sides except a side where light source 115 is electrically coupled to a printed circuit board, as described further below. According to other exemplary implementations, the portion of a backlight may extend into recess 110 and relative to one or multiple sides of light source 115.

According to an exemplary implementation, the portion of the backlight 120 provides the function of aligning the backlight to light source 115. For example, the portion of the backlight 120 may not be transmissive of light. According to another exemplary implementation, the portion of the backlight 120 is transmissive and assists reducing loss of light emitted from light source 115.

According to an exemplary embodiment, a gap 117 exists between light source 115 and backlight 120. According to an exemplary implementation, gap 117 comprises an air gap. According to another exemplary implementation, gap 117 comprises a diffusing film. For example, the diffusing film may assist in spreading the light emitted from light source 115 to backlight 120. According to an exemplary implementation, a gap 118 and a gap 119 exist between light source 115 and housing 105, as illustrated in FIG. 1A. According to an exemplary implementation, as mentioned above (although not illustrated), the portion of backlight 120 may extend into gap 118, gap 119, or both. According to other implementations, gap 118 and gap 119 do not exist, as illustrated in FIG. 1B.

Front window 125 comprises a transparent layer of display configuration 100 through which a user may see visual elements (e.g., graphics, etc.) that are displayed. In addition to being a clear layer, front window 125 may act as a protective covering. For example, front window 125 may be oil resistant (e.g., oil on a human's finger), scratch or abrasion resistant, etc. Front window 125 may be implemented as a film or coating, such as a tempered glass layer or a plastic layer.

Layers 130 comprise other layers of the display. For example, layers 130 may comprise a display layer or display panel, a polarizer layer, a color filter layer, a touch panel, a touchless panel, a touch and touchless panel, etc. According to an exemplary implementation, display configuration 100 comprises a transflective display. For example, layers 130 may comprise layers corresponding to a liquid crystal display (LCD). By way of further example, an exemplary LCD may comprise a polarizer layer, a thin-film transistor (TFT) layer (e.g., TFT glass), and a color filter layer. Layers 130 may also comprise other components not specifically illustrated, such as a display driver, a touch driver, a flexible printed circuit, etc.

Although not illustrated in FIG. 1A, display configuration 100 comprises a printed circuit board. The printed circuit board is illustrated in other figures and described elsewhere in this description.

FIGS. 1B-1G illustrate different views and embodiments of display configurations that comprise an integrated light source in a recess of a housing. FIG. 1B illustrates a cross-sectional view of an exemplary embodiment of a display configuration. Referring to FIG. 1B and in contrast to FIG. 1A, gap 118 and gap 119 do not exist. Rather, a top wall 141 and a bottom wall 142 of housing 105, which forms a portion of recess 140, are proximate to or contact light source 115. According to an exemplary implementation, a portion of backlight 120 protrudes into recess 140. According to another exemplary implementation, backlight 120 does not comprise a portion that protrudes into recess 140.

FIG. 1C illustrates an elevated, isometric, cross-sectional view of yet another exemplary embodiment of a display configuration. Referring to FIG. 1C and in contrast to FIG. 1A, gap 118 and gap 119 do not exist. Additionally, a backlight 150 does not comprise a portion that protrudes into recess 140.

FIG. 1D illustrates an elevated, isometric, cross-sectional view of still another exemplary embodiment of a display configuration. Referring to FIG. 1D and in contrast to some other embodiments, a portion of backlight 160 protrudes into a recess 170. According to such an embodiment, a light source 175 is not external to the portion of backlight 160. Rather, the portion of backlight 160 encases or surrounds light source 175 on multiple sides, except a side 176 of light source 175. For example, side 176 would correspond to the side of light source 175 that makes contact with a connector 310, as illustrated in FIG. 3C.

FIG. 1E illustrates a top view of an exemplary embodiment of a display configuration. Referring to both FIG. 1A and 1E, multiple portions of backlight 120 protrude into recess 110. FIGS. 1F and 1G illustrate still other configurations. For example, referring to FIG. 1F, multiple light sources 115 may be placed in or extend into recess 110, in which a portion of backlight 120 extends into recess 110 at one end of light sources 115 and another portion of backlight 120 extends into recess 110 at another end of light sources 115. Alternatively, for example with regard to FIG. 1G, multiple light sources 115 and a portion of backlight 120 protrude into recess 110 between each light source 115. Nevertheless, any of the embodiments described herein and illustrated in the figures may include one or multiple light sources.

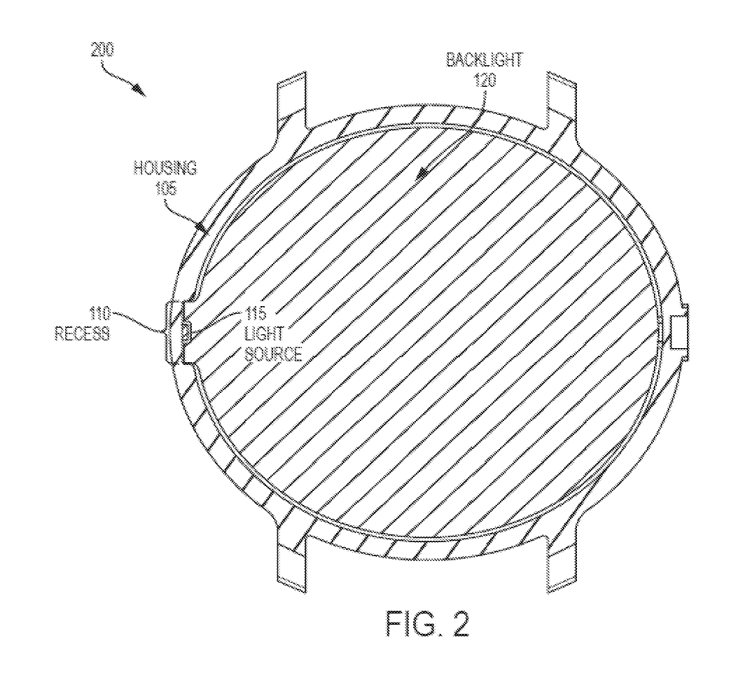

FIG. 2 illustrates a top view of an exemplary embodiment of a display configuration that comprises an integrated light source in a recess of a housing of a device 200. For example, device 200 may be a wearable device, such as a watch. As illustrated, device 200 comprises a round display. The round display comprises an exemplary embodiment of a display configuration that includes housing 105 comprising recess 110, in which light source 115 and backlight 120 are situated in recess 110. The number and/or placement of recess 110, as well as light source 115 and portions of backlight 120, are merely exemplary. According to other embodiments, device 200 may include multiple recesses 110, multiple light sources corresponding to multiple recesses 110, and similarly multiple portions of backlight 120 protruding into multiple recesses 110. Additionally, or alternatively, one or multiple recesses 110 may be situated anywhere around the circumference of the round display. Additionally, or alternatively, other embodiments of a display configuration may be implemented relative to device 200, such as an embodiment that a portion of backlight 120 does not protrude into recess 110, etc.

FIGS. 3A and 3B illustrate cross-sectional views of exemplary embodiments of a display configuration that comprises an integrated light source in a recess of a housing. As previously described, light source 115 connects to a printed circuit board. Referring to FIG. 3A, connector 310 connects light source 115 to a printed circuit board 305. According to an exemplary implementation, printed circuit board 305 comprises a management unit 315. For example, management unit 315 may be an LMU or a PMU. FIG. 3B illustrates another exemplary implementation in which connector 310 connects light source 115 to management unit 315 of printed circuit board 305. As illustrated in FIG. 3B, connector 310 extends downward a side surface of housing 105 and towards a bottom-side of printed circuit board 305. Although FIGS. 3A and 3B illustrate that recess 110 comprises gap 118 and gap 119, according to other embodiments, and as described above, recess 110 may not include gap 118 and gap 119. Additionally, or alternatively, although FIGS. 3A and 3B do not illustrate a portion of backlight 120 protruding into recess 110, according to other exemplary embodiments, one or multiple portions of backlight 120 may protrude into recess 110.

FIG. 3C illustrates an isometric view of connector 310. As illustrated, recess 110 comprises an electrical contact area 325. Electrical contact area 325 provides a connection to light source 115. Additionally, as illustrated, an electrical pathway 330 provides a connection from electrical contact area 325. For example, electrical pathway 330 may extend to management unit 315 of printed circuit board 305. Although electrical contact area 325 is illustrated as residing on a particular wall that defines the recess, according to other implementations, electrical contact area 325 may reside on multiple walls of the recess and/or on a different wall that defines the recess than illustrated in FIG. 3C. In this way, the orientation of the light source and/or the number and positioning of the light source may be configured.

As further illustrated in FIG. 3C, recess 110 may include guiding holes (e.g., guiding holes 370-1 and 370-2, referred to herein as guiding holes 370). For example, guiding holes 370 may be a point of attachment for portions of the backlight to attach to the housing. In this way, guiding holes 370 may facilitate the coupling of the backlight to the light emitted by the light sources. For example, as illustrated in FIG. 3D, which is a top view, a portion of backlight 390-1 may be guided into guiding hole 370-1 and a portion of backlight 390-2 may be guided into guiding hole 370-2.

Additionally, as previously described, according to an exemplary implementation, the portion of the backlight that protrudes into the recess may be transmissive of light. For example, portions of backlight 390-1 and 390-2 may receive emitted light 391 from light sources 115. Additionally, the portions 390-1 and 390-2 may provide attachment functionality relative to housing 105. Alternatively, the portion of the backlight that protrudes into the recess may not be transmissive of light. According to yet another exemplary implementation, a segment of portions 390-1 and 390-2 may be transmissive of light and another segment of portions 390-1 and 390-2 may not be transmissive of light. For example, as illustrated in relation to portion of backlight 390-2, portion of backlight 390-2 may be divided into a transmissive segment 393 and a non-transmissive segment 394.

While FIGS. 3A and 3B illustrate that printed circuit board 305 comprises management unit 315, according to other embodiments, printed circuit board 305 may not comprise management unit 315. For example, printed circuit board 305 may be an intermediary component. According to such an embodiment, printed circuit board 305 may connect to another printed circuit board (not illustrated) that comprises management unit 315. Management unit 315 may transmit driving signals to light source 115 via connector 310.

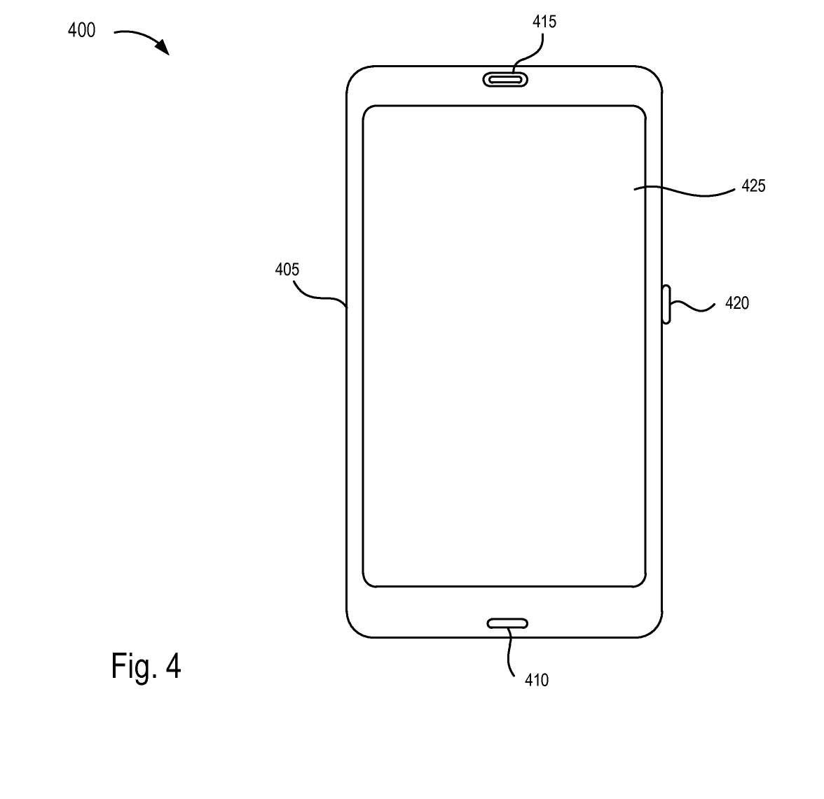

Embodiments of display configuration described herein may be implemented within various types of user devices. FIG. 4 illustrates an exemplary user device 400 in which an embodiment of the integrated backlight in housing may be implemented. While illustratively speaking based on FIG. 4, user device 400 may be representative of, for example, a smartphone, a cellphone, or a personal digital assistant (PDA), user device 400 may be implemented as various other types of user devices. For example, user device 400 may take the form of a tablet device, a data organizer, a picture capturing device, a video capturing device, a Web-access device, a computer, a palmtop device, a netbook, a gaming device, a location-aware device, a music playing device, a television, or some other type of consumer device that comprises a display. Alternatively, user device 400 may be implemented as a non-consumer device, a non-mobile device, or any other form of an electronic device. As illustrated in FIG. 4, user device 400 comprises a housing 405, a microphone 410, a speaker 415, a button 420, and a display 425. According to other embodiments, user device 400 may comprise fewer components, additional components, different components, and/or a different arrangement of components than those illustrated in FIG. 4 and described herein.

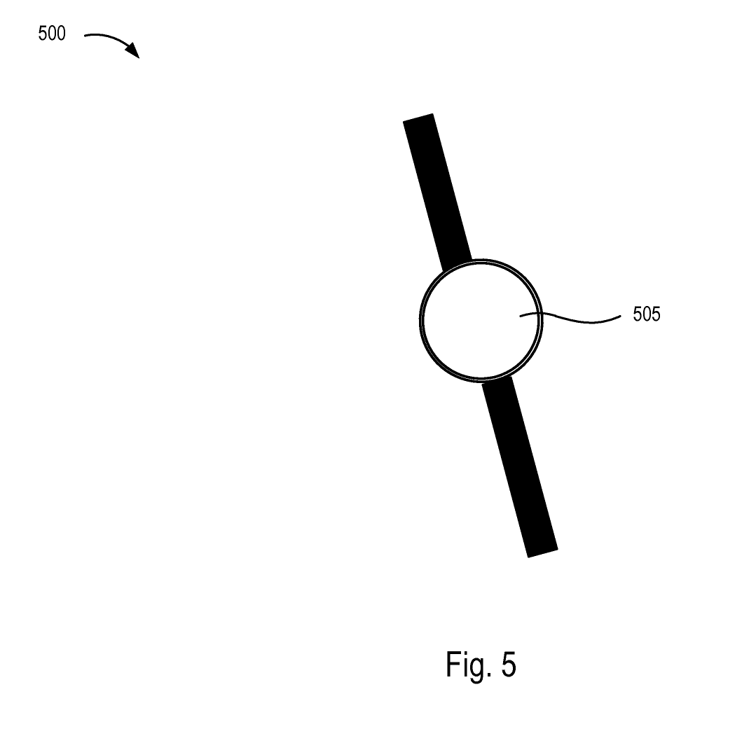

FIG. 5 illustrates another example of a user device 500 in which an embodiment of the display configuration comprising an integrated light source in a recess of a housing may be implemented. In this example, user device 500 is representative of a wearable device (e.g., a watch-type user device) that comprises a circular display 505. Circular display 505 may be implemented based on display configuration 100 or other embodiments of display configurations, as described herein.

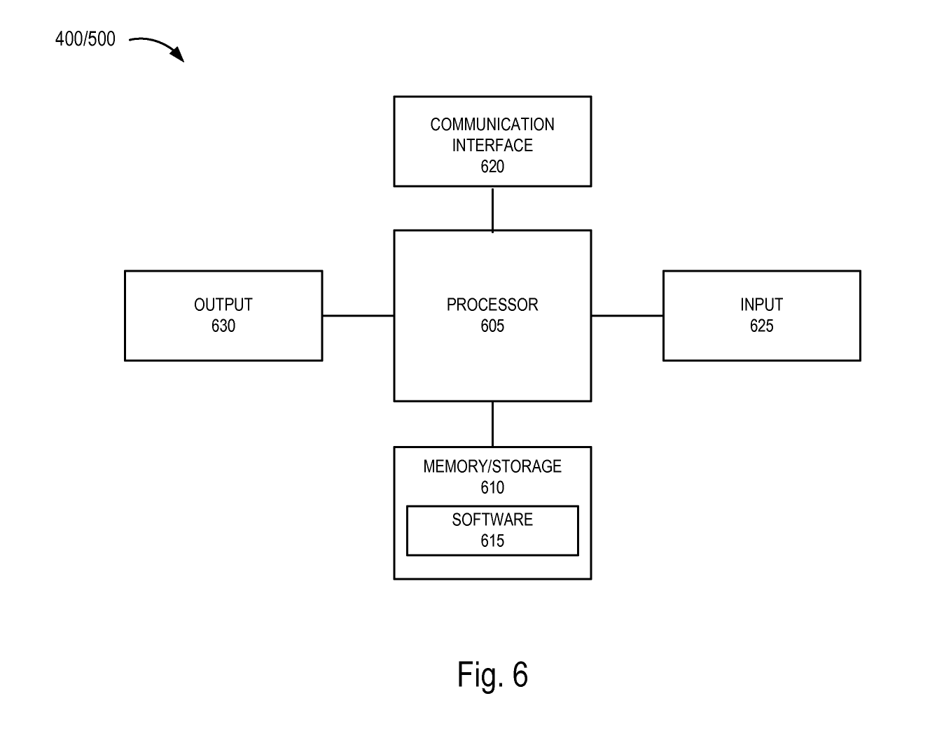

FIG. 6 illustrates exemplary components of user devices 400 and 500 (simply referred to as user device 400). As illustrated, according to an exemplary embodiment, user device 400 comprises a processor 605, memory/storage 610, software 615, a communication interface 620, an input 625, and an output 630. According to other embodiments, user device 400 may comprise fewer components, additional components, different components, and/or a different arrangement of components than those illustrated in FIG. 6 and described herein.

Processor 605 comprises one or multiple processors, microprocessors, data processors, co-processors, and/or some other type of component that interprets and/or executes instructions and/or data. Processor 605 may be implemented as hardware (e.g., a microprocessor, etc.) or a combination of hardware and software (e.g., a system-on-chip (SoC), an application-specific integrated circuit (ASIC), etc.). Processor 605 performs one or multiple operations based on an operating system and/or various applications or programs (e.g., software 615).

Memory/storage 610 comprises one or multiple memories and/or one or multiple other types of storage mediums. For example, memory/storage 610 may include a random access memory (RAM), a dynamic random access memory (DRAM), a cache, a read only memory (ROM), a programmable read only memory (PROM), and/or some other type of memory. Memory/storage 610 may include a hard disk (e.g., a magnetic disk, an optical disk, a magneto-optic disk, a solid state disk, etc.).

Software 615 comprises an application or a program that provides a function and/or a process. Software 615 may include firmware. By way of example, software 615 may comprise a telephone application, a multi-media application, an e-mail application, a contacts application, a calendar application, an instant messaging application, a web browsing application, a location-based application (e.g., a Global Positioning System (GPS)-based application, etc.), a camera application, etc. Software 615 comprises an operating system (OS). For example, depending on the implementation of user device 600, the operating system may correspond to iOS, Android, Windows Phone, Symbian, or another type of operating system (e.g., proprietary, BlackBerry OS, Windows, Linux, etc.).

Communication interface 620 permits user device 600 to communicate with other devices, networks, systems, etc. Communication interface 620 may include one or multiple wireless interfaces and/or wired interfaces. Communication interface 620 may include one or multiple transmitters, receivers, and/or transceivers. Communication interface 620 operates according to one or multiple protocols, a communication standard, and/or the like.

Input 625 permits an input into user device 400. For example, input 625 may include a button, a switch, a touch pad, an input port, speech recognition logic, and/or a display (e.g., a touch display, a touchless display). Output 630 permits an output from user device 400. For example, output 630 may include a speaker, a display, a light, an output port, and/or some other type of output component.

User device 400 may perform a process and/or a function in response to processor 605 executing software 615 stored by memory/storage 610. By way of example, instructions may be read into memory/storage 610 from another memory/storage 610 or read into memory/storage 610 from another device via communication interface 620. The instructions stored by memory/storage 610 causes processor 605 to perform the process or the function. Alternatively, user device 400 may perform a process or a function based on the operation of hardware (processor 605, etc.). As previously described above, according to an exemplary implementation, printed circuit board 305 may be a main printed circuit board of a user device. According to such an implementation, printed circuit board 305 may include various components illustrated and described in relation to FIG. 6. For example, printed circuit board 305 may comprise processor 605, memory 610, communication interface 620, etc.

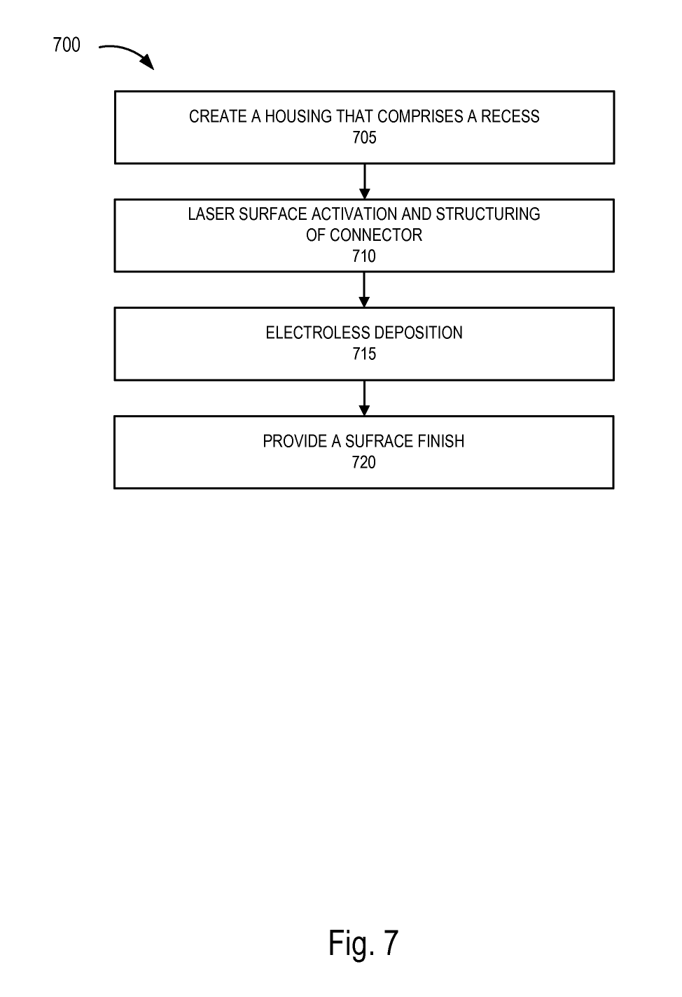

FIG. 7 is a flow diagram illustrating an exemplary process 700 for creating an article of manufacture that comprises a recess portion of a housing.

In block 705, a housing that comprises a recess is created. For example, housing 105 or a portion of housing 105 that comprises a recess, such as recess 110 illustrated in FIG. 1A, is created. According to an exemplary implementation, injection molding is used to create housing 105 or a portion of housing 105.

In block 710, laser surface activation and structuring of a connector is performed. For example, a surface of housing 105 is activated by selective laser irradiation, which results in a structuring of connector 310.

In block 715, electroless deposition is performed. For example, electroless deposition of a conductive material (e.g., a metal) is performed relative to the structuring of connector 310.

In block 720, a surface finish is provided. According to an exemplary implementation, a coating may be applied to protect the metal. According to another exemplary implementation, before surface finishing is performed, a full build of metal plating may be performed.

Although FIG. 7 illustrates an exemplary process 700, according to other embodiments, process 700 may comprise additional steps, fewer steps, and/or different steps than those illustrated in FIG. 7 and described.

Connector 310 may be created such that connector 310 can be connected to printed circuit board 305. For example, connector 310 may connect to printed circuit board 305 by way of pogo pins, leaf springs, soldered wires, or some other attachment method. According to an exemplary embodiment, light source 115 is assembled into recess 110 having connector 310, subsequent to process 700.

According to another exemplary embodiment, light source 115 is molded into housing 105. For example, light source 115 may be connected to a flexible printed circuit or wiring before light source 115 is molded into housing 105 (e.g., a plastic or composite housing 105). The flexible printed circuit or wiring may then be connected to a printed circuit board by soldering, by hot press, or anisotropic conductive film (ACF). Additionally, for assembly, guiding holes may be formed in the housing to guide the portion of the backlight to the guiding holes, in which the portion of the backlight may be attached.

According to yet another exemplary embodiment, 3D printing technology may be used to print a housing that comprises a recess, and connector. For example, a conductive material may be used to print connector 310.

The foregoing description of embodiments provides illustration, but is not intended to be exhaustive or to limit the embodiments to the precise form disclosed. Accordingly, modifications to the embodiments described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

The terms “comprise,” “comprises” or “comprising,” as well as synonyms thereof (e.g., include, etc.), when used in the specification is meant to specify the presence of stated features, integers, steps, or components but does not preclude the presence or addition of one or more other features, integers, steps, components, or groups thereof. In other words, these terms are to be interpreted as inclusive without limitation.

The word “exemplary” is used herein to mean “serving as an example.” Any embodiment or implementation described as “exemplary” is not necessarily to be construed as preferred or advantageous over other embodiments or implementations.

Spatially relative terms, such as “beneath,” “below,” “lower,” “above,” “upper,” and the like, may be used herein for ease of description to describe one element's or feature's relationship to another element or feature as illustrated in the figures. For example, if the element in the figure is turned over, an element described as “below” or “beneath” another element or another feature would then be oriented “above” the other element or the other feature. Thus, for example, the exemplary terms “below” or “beneath” may encompass both an orientation of above and below depending on the orientation of a display device or a user device. In the instance that the display device may be oriented in a different manner (e.g., rotated at 90 degrees or at some other orientation), the spatially relative terms used herein should be interpreted accordingly.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction described in the present application should be construed as critical or essential to the embodiments described herein unless explicitly described as such.

Use of ordinal terms such as “first,” “second,” “third,” etc., in the claims to modify a claim element does not by itself connote any priority, precedence, or order of one claim element over another, but are used merely as labels to distinguish one claim element having a certain name from another element having a same name (but for use of the ordinal term) to distinguish the claim elements.

what is claimed is:

1. A device comprising:
a housing, wherein the housing comprises one or more recesses;
a display panel;
a backlight;
one or more light sources, wherein within each of the one or more recesses of the housing, one or more of the one or more light sources reside and are configured to emit light into the backlight; and
a printed circuit board, wherein each of the one or more of the one or more light sources are connected to the printed circuit board, and wherein each of the one or more recesses comprises at least one wall that comprises an electrical attachment area for the one or more of the one or more light sources.

2. The device of claim 1, wherein each of the one or more recesses comprises at least one other wall that comprises an electrical pathway towards the printed circuit board, and wherein the one or more of the one or more light sources, within each of the one or more recesses, are connected to the printed circuit board via the electrical pathway.

3. The device of claim 1, wherein the printed circuit board comprises one of a flexible printed circuit, a chip-on-flex, a chip-on-foil, a chip-on-glass, or a main printed circuit board of the device.

4. The device of claim 1, wherein the one or more light sources comprise one or more light-emitting diodes.

5. The device of claim 1, further comprising:
a touch panel operable in at least one of an on-touch mode or a touchless mode, and wherein the display panel comprises a liquid crystal display.

6. The device of claim 1, wherein one or more portions of the backlight protrude into each of the one or more recesses.

7. The device of claim 6, wherein the one or more portions of the backlight surround the one or more of the one or more light sources on all sides of the one or more of the one or more light sources except a side of the one or more of the one or more light sources that is electrically coupled to the at least one wall that comprises an electrical attachment area for the one or more of the one or more light sources.

8. A user device comprising:
a housing, wherein the housing comprises one or more recesses;
a display panel;
a backlight;
one or more light sources, wherein within each of the one or more recesses of the housing, one or more of the one or more light sources reside and are configured to emit light into the backlight; and
a printed circuit board, wherein each of the one or more of the one or more light sources are connected to the printed circuit board, wherein each of the one or more recesses comprises at least one wall that comprises an electrical attachment area for the one or more of the one or more light sources, and wherein the printed circuit board comprises a memory, a processor, and a management unit that transmits driving signals to the one or more light sources.

9. The user device of claim 8, wherein each of the one or more recesses comprises at least one other wall that comprises an electrical pathway towards the printed circuit board.

10. The user device of claim 8, wherein one or more portions of the backlight protrude into each of the one or more recesses.

11. The user device of claim 10, wherein the at least one wall comprises one or more guiding holes configured to receive the one or more portions of the backlight.

12. The user device of claim 11, wherein a segment of each of the one or more portions of the backlight are not transmissive of light.

13. The user device of claim 11, wherein the one or more portions of the backlight are transmissive of light and configured to receive light emitted from the one or light sources.

14. The user device of claim 8, wherein the one or more light sources comprise one or more light-emitting diodes or one or more laser diodes.

15. The user device of claim 8, wherein the user device is a wearable device or a mobile device.

16. A device comprising:
a housing, wherein the housing comprises one or more recesses;
a display panel;
a touch panel operable in at least one of an on-touch mode or a touchless mode;
a backlight;
one or more light sources, wherein within each of the one or more recesses of the housing, one or more of the one or more light sources reside and are configured to emit light into the backlight; and
a printed circuit board, wherein each of the one or more of the one or more light sources are connected to the printed circuit board, and wherein each of the one or more recesses comprises at least one wall that comprises an electrical attachment area for the one or more of the one or more light sources.

17. The device of claim 16, wherein each of the one or more recesses comprises at least one other wall that comprises an electrical pathway towards the printed circuit board, and wherein the one or more of the one or more light sources, within each of the one or more recesses, are connected to the printed circuit board via the electrical pathway.

18. The device of claim 16, wherein one or more portions of the backlight protrude into each of the one or more recesses.

19. The device of claim 16, wherein the one or more light sources comprise one or more light-emitting diodes or one or more laser diodes.

20. The device of claim 16, wherein a gap exists between a side of the one or more of the one or more light sources that emit light and a side of the backlight configured to receive the light emitted, and wherein the gap comprises a diffusing film.
